(19) United States
(12) Patent Application Publication
(10) Pub. No.: US 2006/0087094 A1
(43) Pub. Date: Apr. 27, 2006

(54) ANTI-SLIP STEP FOR A MOTOR VEHICLE AND A METHOD OF FORMING THE SAME

(75) Inventors: Robert M. Byrne, Lima, OH (US); Clifford G. Dalman, Spring Lake, MI (US)

Correspondence Address: RANKIN, HILL, PORTER & CLARK, LLP, 925 EUCLID AVENUE, SUITE 700, CLEVELAND, OH, 44115-1405, US

(73) Assignee: AMERICAN TRIM, LLC, Lima, OH (US)

(21) Appl. No.: 11/163,143

(22) Filed: Oct. 6, 2005

Related U.S. Application Data
(63) Continuation-in-part of application No. 10/725,341, filed on Dec. 1, 2003, now abandoned.

(51) Int. Cl. B60R 3/00

(52) U.S. Cl. 280/166

(57) ABSTRACT

An anti-slip step is provided. The step includes a tread plate with a top surface and a bottom surface. A plurality of grip structures extend upwardly from the top surface of the tread plate and a plurality of drain structures extend downwardly from the bottom surface of the metal plate. Each of the grip structures and the drain structures defines a hole through the tread plate. Each of the grip structures includes a base, having a continuous, curved side wall that is joined to the tread plate, and a plurality of spaced-apart tabs joined to the base and extending upwardly therefrom. Each of the drain structures includes a plurality of spaced-apart tabs joined to the tread plate.

### CROSS-REFERENCE TO RELATED APPLICATION

This application is a continuation-in-part of U.S. application Ser. No. 10/725,341, filed Dec. 1, 2003.

### BACKGROUND OF THE INVENTION

The present invention generally relates to steps, and more particularly, to steps for heavy-duty motor vehicles, such as industrial trucks, to facilitate the ingress and egress of operators to and from cabs of the trucks.

Truck steps are conventionally constructed from metal plates having planar support surfaces. Grip structures are typically formed in the support surface to prevent slippage, especially when the step is wet or covered with ice. Drainage holes may also be formed in the metal plate to allow water to drain from the support surface. The grip structures are disposed around openings in the plate and usually have curved side walls defining continuous top rims. While grip structures of this construction will improve the grip of a step, the continuous nature of the top rims can still render the top rims and, thus the step, quite slippery when the step is wet or covered with ice. In order to address this deficiency of conventional grip structures, other grip structures have been developed. Such grip structures are disclosed in U.S. Pat. No. 3,181,440 to Mullaney et al. and U.S. Pat. No. 4,343,119 to Bahnfleth.

The rosette of the Bahnfleth patent includes a plurality of spaced-apart extensions having arcuate edges. The extensions slope inwardly to provide the rosette with a relatively narrow cross-shaped opening. Although contact portions of the rosette edges are discontinuous in a plane of contact, these contact portions are small. Moreover, the slope of the extensions presents major surfaces that are located just below the contact portions. These major surfaces can become slippery when the rosette is wet or covered with ice. Moreover, the narrowness of the opening in the rosette can make the rosette susceptible to clogging with dirt or ice.

The grip structures of the Mullaney et al. patent comprise cylindrical flanges that extend upright from a metal tread plate 14. Top portions of the flanges are gulleted to provide a number of fairly deep truncated gripping edges. In order to increase the height of the flanges and permit the flanges to extend upright, the flanges are thinned. With the foregoing high-profile construction, the flanges may trap footwear and cause injury if they are not properly spaced apart. For this reason, the Mullaney et al. patent discloses that the flanges must be spaced closely together. Such close spacing, however, may not always be desirable.

Based on the foregoing, there is a need in the art for an improved anti-slip step having low profile grip structures. The present invention is directed to such an anti-slip step.

### SUMMARY OF INVENTION

In accordance with the present invention, an anti-slip step for a motor vehicle is provided. The step includes a tread plate with a top surface and a bottom surface. A plurality of grip structures extend upwardly from the top surface of the tread plate. Each of the grip structures defines a hole through the tread plate. In one embodiment of the invention, the grip structures include a base having a continuous, curved side wall that is joined to the tread plate. A plurality of spaced-apart tabs are joined to the base and extend upwardly therefrom. A plurality of drain structures extend downwardly from the bottom surface of the tread plate. Each of the drain structures defines a drain hole through the tread plate.

Also provided in accordance with the present invention is a method of forming an anti-slip step. Pursuant to the method, a tread plate is provided having top and bottom surfaces. A plurality of holes are formed in the tread plate. For at least one of the holes, a boundary region of the tread plate disposed around the hole is bent so as to form a base that extends above a plane defined by the top surface and thereby form a grip structure defining a first opening. For at least another one of the holes, a boundary region disposed around the hole is bent to form a base that extends below a plane defined by the bottom surface and thereby form a drain structure defining a second opening.

### BRIEF DESCRIPTION OF THE DRAWINGS

The features, aspects, and advantages of the present invention will become better understood with regard to the following description, appended claims, and accompanying drawings where:

FIG. 1 is a perspective view of a portion of a step including an exemplary tread plate according to the invention;

FIG. 2 is a top plan view of a portion of the tread plate shown in FIG. 1 showing a grip structure;

FIG. 3 is a side elevation view of the grip structure shown in FIG. 2 as viewed in the direction of the arrows pointing toward the section line A-A shown in FIG. 2;

FIG. 4 is a vertical sectional view of the grip structure shown in FIG. 2 taken along the section line A-A as viewed in the direction of the arrows;

FIG. 5 is a bottom plan view of a portion of the tread plate shown in FIG. 1 showing a drain structure;

FIG. 6 is side elevation view of the drain structure shown in FIG. 5 as viewed in the direction of the arrows pointing toward the section line B-B shown in FIG. 5

FIG. 7 is a vertical section view of the drain structure shown in FIG. 5 taken along the section line A-A as viewed in the direction of the arrows;

FIG. 8 is a top plan view of a an alternative grip structure according to the invention;

FIG. 9 is a side elevation view of the alternative grip structure shown in FIG. 8 as viewed in the direction of the arrows pointing toward the section line C-C shown in FIG. 8; and

FIG. 10 is vertical sectional view of the alternative grip structure shown in FIG. 8 taken along the section line C-C as viewed in the direction of the arrows.

FIG. 11 is a top plan view of a tread plate as a grip structure is being formed according to the invention.

FIG. 12 is a bottom plan view of a tread plate as a drain structure is being formed according to the invention.

### DETAILED DESCRIPTION OF THE PREFERRED EMBODIMENTS

It should be noted that in the detailed description that follows, in order to clearly and concisely disclose the present invention, the drawings may not necessarily be to scale and certain features of the invention may be shown in somewhat schematic form.

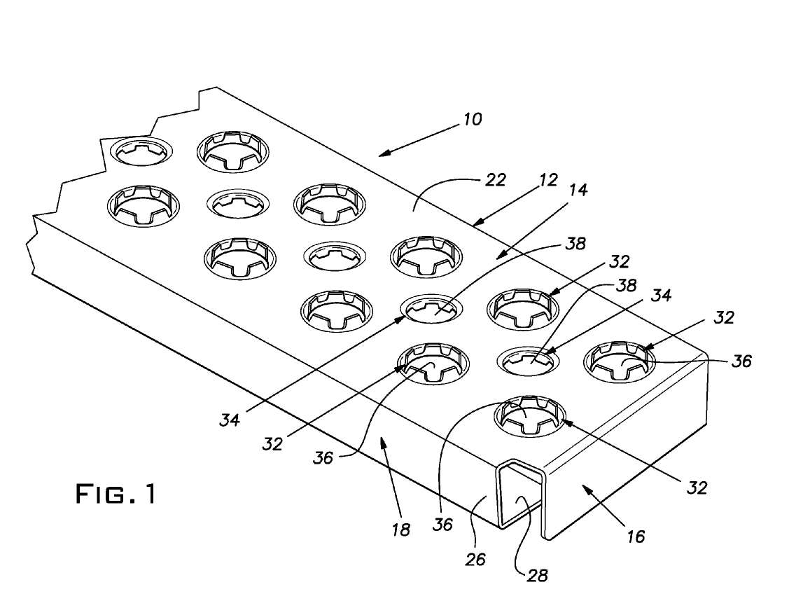

Referring now to FIG. 1, there is shown a portion of a step 10 embodied in accordance with the present invention. The step 10 is particularly suitable for installation on a motor vehicle such as, for example, an industrial truck having an elevated cab (e.g., a dump truck or a tractor for pulling a semi-trailer). The step 10 includes a support structure 12 that is preferably composed of a metal, such as aluminum. The support structure 12 includes a tread plate 14, a pair of opposing end flanges 16 (only one of which is shown in FIG. 1), front flange 18 and an opposing rear flange (not shown, but the rear flange is a mirror image of the front flange 18). The tread plate 14 is generally rectangular and includes top and bottom surfaces 22, 24. The end flanges 16 extend downwardly from opposing ends of the tread plate 14 at bends. Although not shown in FIG. 1, the end flanges 16 may have holes formed therein for receiving screws, bolts or other elongated fasteners that may be used to secure the step 10 between side supports or mounts. The front flange 18 and the rear flange extend downwardly from opposing side portions of the tread plate 14 at bends. Each of the front flange 18 and the rear flange preferably has an L-shaped cross-section and includes a downwardly-extending substantially vertical first member 26 joined at a bend to a inwardly-extending substantially horizontal second member 28 so as form an interior ledge. In each of the front flange 18 and the rear flange, the first and second members 26, 28 are preferably disposed at least substantially perpendicular to each other. The second members 28 of the front and rear flanges 18, 20 are preferably disposed at least substantially parallel to the tread plate 14. The support structure 12 is preferably formed from a single metal plate by appropriately cutting out the corners of the single plate and appropriately bending front, rear and end portions of the single plate to form the end flanges 16, the front flange 18 and the rear flange, respectively.

A plurality of grip structures 32 and drain structures 34 are formed in the tread plate 14. The grip structures 32 define grip openings 36, and the drain structures 34 define drain openings 38. The top surface 22 of the tread plate 14 defines a top plane, and the bottom surface 24 of the tread plate 14 defines a bottom plane. The grip structures 32 extend upwardly from the top plane of the tread plate 14, while the drain structures 34 extend downwardly from the bottom plane of the tread plate 14. The grip structures 32 provide non-continuous gripping to footwear brought into contact with the tread plate 14, while the drain structures 34 facilitate the drainage of water from the top surface 22 of the tread plate 14 so as to prevent the pooling of water thereon.

Preferably, the grip structures 32 and the drain structures 34 are arranged such that the tread plate 14 has alternating longitudinally extending rows of grip structures 32 and drain structures 34. In the specific version of the invention disclosed in FIG. 1, there is a longitudinal middle row of drain structures 34 disposed between longitudinal front and rear rows of the grip structures 32. It should be appreciated, however, that the present invention is not limited to this particular arrangement of the grip structures 32 and the drain structures 34.

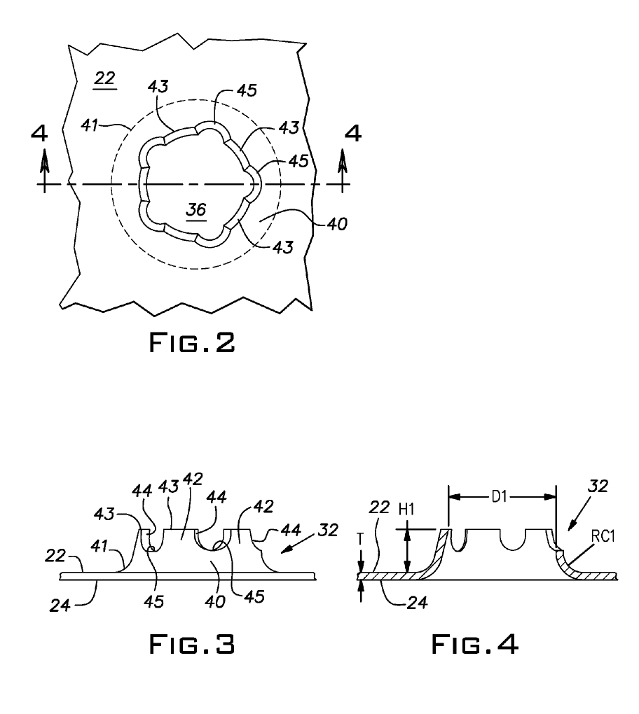

Referring now to FIGS. 2-4, in one embodiment of the invention the grip structures 32 comprise a base portion 40 that extends from the top surface 22 of the tread plate 14. The transition 41 between the base portion 40 and the top surface 22 of the treat plate 14 is curved or arcuate when viewed in a section taken perpendicular to the top plane defined by the top surface 22 of the tread plate 14. The base portion 40 preferably comprises a continuous curved or arcuate side wall. A plurality of tabs 42 are joined to, and extend upwardly from, the base portion 40. The base portion 40 and each of the tabs 42 have at least substantially the same thickness as the thickness of the tread plate 14.

In the embodiment shown in FIGS. 2-4, the area or space between adjacent tabs 42, which is sometimes referred to herein as a “notch”, is generally “U” shaped. However, it will be appreciated that the shape of the notch is not per se critical, and that a variety of notch shapes can be used. Each notch is defined by a side edge 44 of adjacent tabs 42, and by a top edge 45 of the base 40. The transition from the top edge 43 to the side edges 44 in the grip structure 32 shown in FIGS. 2-4 is angular and near 90°, but can be less acute or curved, if desired. The transition between the side edges 44 and the top edge 45 of the base 40 in the grip structure 32 shown in FIGS. 2-4 is curved, but could be angular if desired. All of the top edges 43 of all of the tabs 42 in each grip structure 32 preferably lie in the same plane, which is parallel to the top plane defined by the top surface 22 of the tread plate 14.

The top edge 45 of the base 40, and the side edges 44 and top edge 43 of the tabs 42 define a grip opening 36, which has a diameter “D1”, and is positioned above the top plane defined by the top surface 22 of the tread plate 14. The top edge 45 of the base 40, and the side edges 44 and top edge 43 of the tabs 42 also cooperate to form a plurality of alternating ridges and valleys, wherein the ridges are defined by the top edges 43 of the tabs 42 and the valleys are defined by the top edges 45 of the base 40. The grip structures shown in FIGS. 2-4 feature five equally spaced apart tabs 42 surrounding a grip opening 36. It will be appreciated that the number of tabs 42 surrounding the grip opening 36 is not per se critical.

The top edge 43 of the tabs 42 are disposed a height “H1” above the top plane defined by the top surface 22 of the tread plate 14. In the grip structure 32 shown in FIGS. 2-4, the transition 41 between the top surface 22 of the tread plate 14 and the base 40 defines a radius of curvature “RC1”. The ratio of the radius of curvature RC1 to the height H1 of the grip structure (i.e., RC1/H1) is preferably greater than 0.5, more preferably greater than 0.75, still more preferably greater than 1. In addition, each grip structure 32 is constructed such that the ratio of the height H1 of the grip structure to the diameter D1 of the grip opening of the grip structure (i.e., H1/D1) is less than 0.75, more preferably less than 0.5, still more preferably less than 0.3. Furthermore, the ratio of the height H1 of each grip structure 32 to the thickness “T” of the tread plate 14 (i.e., H1/T) is preferably less than 3, more preferably less than 2. With the foregoing structure, the grip structures 32 have low profiles that do not require the grip structures 32 to be disposed closely together.

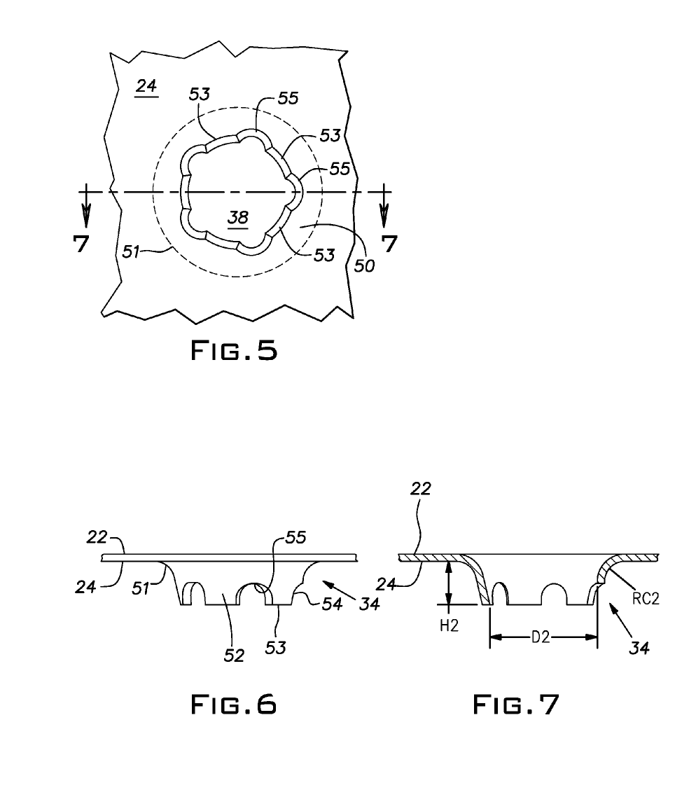

Referring now to FIGS. 5-7, in one embodiment of the invention the drain structures 34 comprise a base portion 50 that extends from the bottom surface 24 of the tread plate 14. The transition 51 between the base portion 50 and the bottom surface 24 of the treat plate 14 is curved or arcuate when viewed in a section taken perpendicular to the bottom plane defined by the bottom surface 24 of the tread plate 14. The base portion 50 preferably comprises a continuous curved or arcuate side wall. A plurality of tabs 52 are joined to, and extend downwardly from, the base portion 50. The base portion 50 and each of the tabs 52 have at least substantially the same thickness as the thickness of the tread plate 14.

In the embodiment shown in FIGS. 5-7 the area or space between adjacent tabs 52, which is sometimes referred to herein as a “notch”, is generally “U” shaped. However, it will be appreciated that the shape of the notch is not per se critical, and that a variety of notch shapes can be used. Each notch is defined by a side edge 54 of adjacent tabs 52, and by a bottom edge 55 of the base 50. The transition from the bottom edge 53 to the side edges 54 in the drain structure 34 shown in FIGS. 5-7 is angular and near 90°, but can be less acute or curved, if desired. The transition between the side edges 54 and the bottom edge 55 of the base 50 in the drain structure 34 shown in FIGS. 5-7 is curved, but could be angular if desired. All of the bottom edges 53 of all of the tabs 52 in each drain structure 52 preferably lie in the same plane, which is parallel to the bottom plane defined by the bottom surface 24 of the tread plate 14.

The bottom edge 55 of the base 50, and the side edges 54 and bottom edge 53 of the tabs 52 define a drain opening 38, which has a diameter “D2”, and is positioned below the bottom plane defined by the bottom surface 24 of the tread plate 14. The drain structures shown in FIGS. 5-7 feature five equally spaced apart tabs 52 surrounding a drain opening 38. It will be appreciated that the number of tabs 52 surrounding the drain opening 38 is not per se critical.

The bottom edges 53 of the tabs 52 are disposed a depth “H2” below the bottom plane defined by the bottom surface 24 of the tread plate 14. In the drain structure 34 shown in FIGS. 5-7, the transition 51 between the bottom surface 24 of the tread plate 14 and the base 50 defines a radius of curvature “RC2”. The ratio of the radius of curvature RC2 to the depth H2 of the drain structure 34 (i.e., RC2/H2) is greater than 1, more preferably greater than 2, still more preferably greater than 3. Preferably, the radius of curvature RC2 of the drain structures 34 is at least substantially the same as the radius of curvature RC1 of the grip structures 32. The diameter D2 of the drain openings 38 of the drain structures 34 is preferably at least substantially the same as the diameter D1 of the grip openings 36 of the grip structures 32. The depth H2 of the drain structures 34, however, is preferably less than the height H1 of the grip structures 32. Still more preferably, the ratio of the depth H2 of the drain structures 34 to the height H1 of the grip structures 32 (H2/H1) is less than 1, more preferably less than 0.75, still more preferably less than 0.5. In lieu of having the construction described above, the drain structures 34 may have the same structure (with the same dimensions) as the grip structures 32, except that the drain structures 34 extend downwardly from the tread plate 14 whereas the grip structures 32 extend upwardly from the tread plate 14. In such a configuration, the grip structures 32 and drain structures 34 can be formed using the same tools simply by flipping the tread plate 14 over.

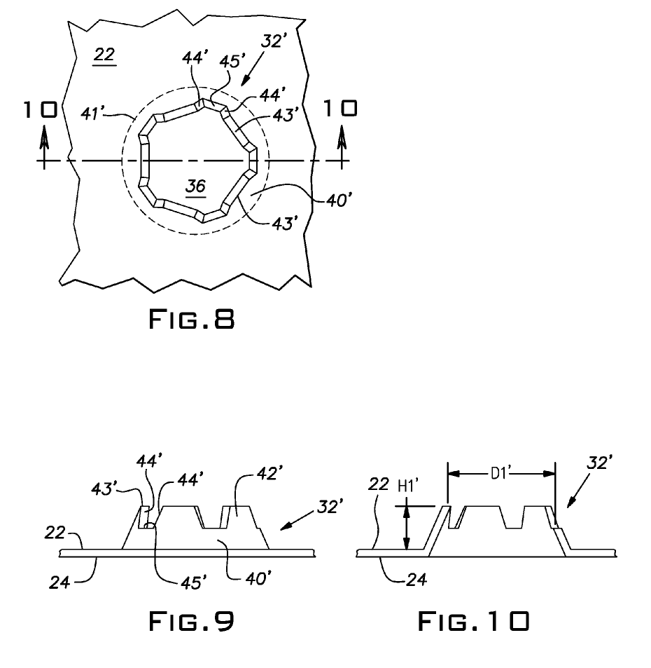

FIGS. 8-10 show an alternative preferred embodiment of a grip structure 32′ in which the transition 41′ between the top surface 22 of the tread plate 14 and the base 40′ is angular rather than curved when viewed in a section taken perpendicular to the top plane defined by the top surface 22 of the tread plate 14. In this embodiment, the base 40′ and tabs 42′ joined thereto are frusto-conical in shape rather than curved or arcuate. As in the embodiment shown in FIGS. 2-4, a plurality of tabs 42′ are joined to, and extend upwardly from, the base portion 40′. The base portion 40′ and each of the tabs 42′ have at least substantially the same thickness as the thickness of the tread plate 14. Preferably, each of the tabs 42′ has a substantially angular shape, with a pair of non-parallel sides 44′ extending downwardly and outwardly from a top edge 43′. The top edges 43′ of the tabs 42′ are preferably flat, as are the top edges 45′ of the base 40′, and are parallel to the top plane defined by the top surface 22 of the tread plate 14. Furthermore, the ratio of the height H1′ of the grip structure 32′ to the diameter D1′ of the grip opening 36 of the grip structure 32′ (i.e., H1′/D1′) is also the same as in FIGS. 2-5. It will be appreciated that drain structures can also be formed having the same frusto-conical shape as the grip structures 32′ shown in FIGS. 8-10, provided that the drain structures extend downwardly from the tread plate 14.

Preferably, each of the grip structures and each of the drain structures is formed using a punching operation and an embossing operation, wherein in the punching operation, a hole is formed in the tread plate and in the embossing operation, a boundary region of the tread plate around the hole is pushed away from the tread plate so as to create a base and tabs that extend out of the plane of the tread plate. The size of the holes for forming the drain structures can be the same as the size of the holes for forming the grip structures, but more preferably the size of the holes for forming the drain structures are about 13% larger than the size of the holes for forming the grip structures, which results in a shallower depth. In another embodiment of the present invention, all of the holes for the grip structures 32 and the drain structures 34 have the same size and configuration.

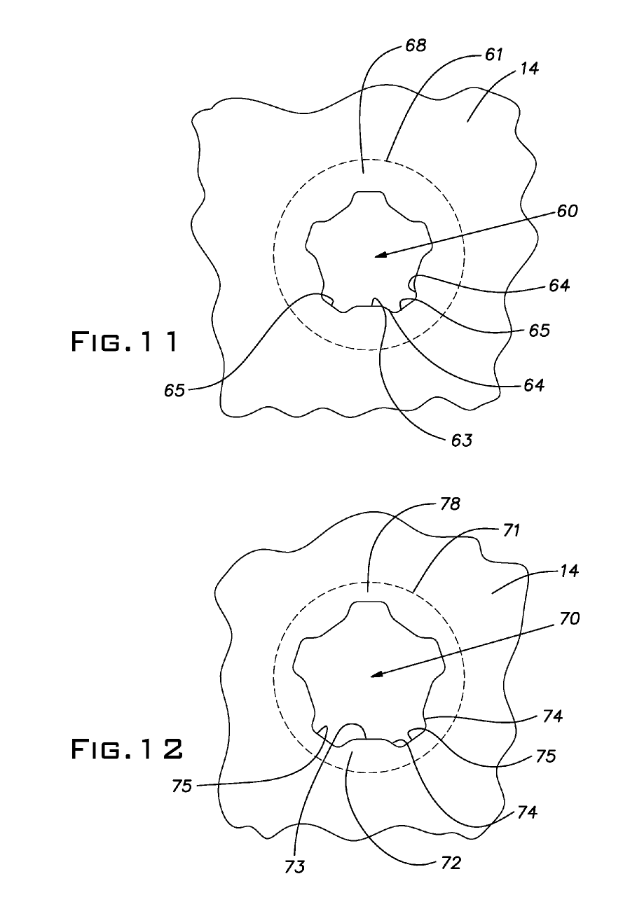

With reference to FIG. 11, in the punching operation, a hole 60 for forming a grip structure 32 such as depicted in FIGS. 2-4 is punched in the tread plate 14. The hole 60 is generally star-shaped, with the distal peripheral portions 65 of the generally star-shaped hole 60 ultimately becoming the top edges 45 of the base 40 and the proximal peripheral portions 63 of the generally star-shaped hole 60 ultimately becoming the top edges 43 of the tabs 42, and with the connecting portions 64 of the generally star-shaped hole 60 between the distal peripheral portion 65 and the proximal peripheral portions 63 ultimately becoming the sides 44 of the tabs 42. In the embossing operation, embossing dies are used to press a region 68 surrounding the generally star-shaped hole 60 upwardly out of the top plane defined by the top surface 22 of the tread plate to form the grip structure 32. The boundary 61 of the region 68 that is pressed upwardly out of the top plane is the transition 41 between the top surface 22 of the tread plate 14 and the base 40. A curved embossing die creates a curved or arcuate base 40. Frusto-conical embossing dies can be used to create grip structures (e.g., such as depicted in FIGS. 8-10).

With reference to FIG. 12, in the punching operation, a hole 70 for forming a drain structure 34 such as depicted in FIGS. 5-7 is punched in the tread plate 14. The hole 70 is generally star-shaped, with the distal peripheral portions 75 of the generally star-shaped hole 70 ultimately becoming the bottom edges 55 of the base 50 and the proximal peripheral portions 73 of the generally star-shaped hole 70 ultimately becoming the bottom edges 53 of the tabs 52, and with the connecting portions 74 of the generally star-shaped hole 70 between the distal peripheral portion 75 and the proximal peripheral portions 73 ultimately becoming the sides 54 of the tabs 52. In the embossing operation, embossing dies are used to press a region 78 surrounding the generally star-shaped hole 70 downwardly out of the bottom plane defined by the bottom surface 24 of the tread plate to form the drain structure 34. The boundary 71 of the region 78 that is pressed downwardly out of the bottom plane is the transition 51 between the bottom surface 24 of the tread plate 14 and the base 50. As in the case of the process for forming grip structures, a curved embossing die creates a curved or arcuate base 50. Frusto-conical embossing dies can be used to create frusto-conical drain structures.

From the foregoing description, it should be appreciated that the step of the present invention is simple to produce, has improved anti-slip features and facilitates the drainage of water from the step. The low profile of the grip structures permits the grip structures to be more spread out without increasing the risk of trapping footwear. While the step is especially adapted for use on an industrial truck having an elevated cab, the step can also be used in other applications, such as on ships and on fixed structures, such as elevated industrial walkways.

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

What is claimed is:

1. An anti-slip step comprising:
a tread plate formed of a sheet of metal having a top surface that defines a top plane and a bottom surface that defines a bottom plane;
a plurality of grip structures that extend upwardly from the top surface of the tread plate, each of the grip structures comprising:
a base comprising a continuous side wall that extends upwardly from a transition between the top surface of the tread plate and the base; and
a plurality of spaced-apart tabs that extend upwardly from the base, each of the tabs having
a top edge, and
a pair of opposing side edges that extend downwardly from the top edge of the tab to a top edge of the base between the spaced-apart tabs,
wherein the top edges and the side edges of the plurality of tabs and the top edges of the base cooperate to define a periphery of an opening of a hole through the tread plate, the periphery the opening lying above the top plane; and
a plurality of drain structures extending downwardly from the bottom surface of the tread plate, wherein each of the drain structures defines a periphery of an opening of a drain hole through the tread plate.

2. The anti-slip step of claim 1, wherein each drain structure further comprises a plurality of spaced-apart downwardly extending tabs.

3. The anti-slip step of claim 2, wherein the tabs of the drain structures are joined to a drain base comprising a continuous side wall that extends downwardly from a transition between the bottom surface of the tread plate and the drain base.

4. The anti-slip step of claim 2, wherein the tabs of the drain structures each have a substantially angular shape.

5. The anti-slip step of claim 1, wherein the tabs of the grip structures each have a substantially angular shape.

6. The anti-slip step of claim 1, wherein the grip structures are arranged in at least two longitudinal rows on the step and the drain structures are arranged in at least one longitudinal row on the step, and wherein the at least one row of the drain structures is disposed between the at least two rows of the grip structures.

7. The anti-slip step of claim 6, wherein the at least one row of the drain structures and the at least two rows of the grip structures are parallel to each other.

8. The anti-slip step of claim 1, wherein in each of the grip structures, the top edges of the tabs are the same length as the top edges of the base.

9. The anti-slip step of claim 1 wherein the continuous side wall of the base of at least one of the grip structures extending from the top surface of the tread plate is curved.

10. The anti-slip step of claim 1 wherein the continuous side wall of the base of at least one the grip structures extending from the top surface of the tread plate is frusto-conical.

11. The anti-slip step of claim 9 wherein the base has a radius of curvature (RC) and the grip structure has a height (H) measured from the top surface of the tread plate to the top edge of the tab, and the ratio of the ratio of the radius of curvature (RC) to the height (H) of the grip structure is greater than 0.5.

12. The anti-slip step of claim 11, wherein the periphery of the opening of the hole through the tread plate in each of the grip structures has a diameter (D), and wherein in each of the grip structures, the ratio of the height (H) of the grip structure to the diameter (D) of the hole is less than 0.75.

13. The anti-slip step of claim 12, wherein in each of the grip structures, the ratio of the height (H) of the grip structure to the diameter (D) of the hole is less than 0.5.

14. A method of forming a grip structure according to claim 1 comprising:
punching a hole in the tread plate; and
embossing the hole using an embossing die to press a region surrounding the hole upwardly out of the top plane.
